(19) United States
(12) Patent Application Publication
(10) Pub. No.: US 2010/0314296 A1
(43) Pub. Date: Dec. 16, 2010

(54) PIPELINING OF OIL IN EMULSION FORM

(76) Inventors: Luis Pacheco, Bogota DC (CO); Maria Briceño, Panama City (PA); Gustavo Núñez, Panama City (PA)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/696,663

(22) Filed: Jan. 29, 2010

Related U.S. Application Data
(60) Provisional application No. 61/148,306, filed on Jan. 29, 2009.

(51) Int. Cl. C09K 8/52; C10G 33/00; C10G 33/04; F17D 3/00

(52) U.S. Cl. 208/188; 208/187; 507/90; 137/1

(57) ABSTRACT

A means for transporting a dispersion of heavy crude oil and water by conventional pipelines. The dispersion is an emulsion prepared by combining production water with crude oil as well as an adequate surfactant system such that the dispersion stabilizes. The dispersion presents a viscosity of less than about 500 cP allowing it to be pumpable and transportable via conventional pipelines. The dispersion, once it arrives at its final destination, is broken or separated by means of one or more suitable diluents such that the remaining oil meets predetermined specifications for further processing, i.e. refining into lighter fractions.

### RELATED APPLICATION

The present application claims the benefit of U.S. Provisional Application No. 61/148,306 filed Jan. 29, 2009, which is incorporated herein in its entirety by reference.

### FIELD OF THE INVENTION

The present invention relates generally to the transport of crude oil. More specifically, the present invention relates to pipelining crude oil in emulsified form.

### BACKGROUND OF THE INVENTION

Processing of crude oil includes the transport of oil extracted from the oil field to tank farm of a refinery for further processing into lighter fractions. Often times, the tank farms are significant distances from the oil fields. Transporting the heavy crude oils can be accomplished via any of a number different ways including pipelining, trucking, and other such suitable means for transporting crude oil.

Transporting of crude oil via vehicles, such as oil tankers or trucks and the like, is cost variable and is heavily dependent on the cost of fuel. Recently, this method has become increasingly expensive due to the increasing gas prices. This method can become easily cost prohibitive as the distance between the oil field and the tank farm increases.

Pipelining of crude oil, either below or above land, is a more cost efficient method of transporting the crude oil between the oil field and the tank farms. Oil pipelines are typically made from either steel or plastic tubes with inner diameter typically from 10 to 120 cm, or about 4 to 48 inches. Most underground pipelines are buried at a depth of about 1-2 meters, or about 3 to 6 feet. The oil is kept in motion by pump stations along the pipeline, and usually flows at speed of about 1 to 6 m/s.

Crude oil contains varying amounts of wax, or paraffin, and in colder climates wax buildup may occur within a pipeline. Often these pipelines are inspected and cleaned using pipeline inspection gauges pigs, also known as scrapers. These devices are launched from pig-launcher stations and travel through the pipeline to be received at any other station down-stream, cleaning wax deposits and material that may have accumulated inside the line.

Heavy and extra heavy crude oil in its natural form has a density from about 7 to about 14 degrees API, and a viscosity from about 10³ to about 10⁶ cP at 25 degrees centigrade. API, also known as API gravity, stands for American Petroleum Institute gravity. It is a measure of the relative density of petroleum liquid and the density of water, and is used to compare relative densities of petroleum liquids. For example, if a petroleum liquid's API is more than ten, it is lighter than and floats on water. If one petroleum liquid has a higher API gravity than a second petroleum liquid, it is lighter than and floats on the second petroleum liquid.

Due to the relatively low API gravity and high viscosity of crude oil, it takes an extraordinary amount of energy to pump the crude oil in its natural form, if it can be pumped at all. Similar to transport via oil trucks, as the distance between the oil field and the tank farm increases, pipelining of pure crude oil becomes increasingly expensive and cost prohibitive.

It is known that making oil-in-water emulsions to lower the viscosity of the crude oil to make it more pumpable, requires less energy than the previously described alternatives. However, these prior art oil-in-water emulsions typically have high water contents, such that a large volume of emulsion must be transported to move the crude oil.

There remains a need for a process for pipelining of heavy crude oil over long distances from the oil field to tank farms wherein the oil is of a pumpable, transportable viscosity, while meeting specifications for further refinery processing, i.e. lighter fractions.

### SUMMARY OF THE INVENTION

Embodiments of the present invention overcome many of the above-described deficiencies. Embodiments of the invention include a dispersion of heavy crude oil and water that can be transported by conventional pipelines. The dispersion is an emulsion prepared by combining production water with crude oil as well as an adequate surfactant system such that the dispersion stabilizes.

In particular, heavy crude oil is dispersed within the water phase as droplets having sizes distributed between about 0.5 to about 500 μm. This distribution can be referred to as a droplet size distribution and can be represented, for example, in a frequency plot as % volume or mass as a function of droplet size. Droplet size distributions can be characterized by statistical parameters such as a mean value and a standard deviation. A size distribution of an emulsion can be unimodal meaning that there is a single most frequent value or peak, bimodal (two peak values), or polymodal (more than two peaks). Polymodal emulsions tend to be less viscous than unimodal emulsions, whereas bimodal emulsions that have a large droplet size to small droplet size ratio close to ten, are less viscous than unimodal or polymodal systems.

The viscosity of an emulsion is also a function of oil content. A small increase of oil can have a strong impact on viscosity. Modifying droplet size distribution as explained above can compensate for an increase in oil content by reducing or keeping a constant viscosity.

Embodiments of the present invention include preparation of unimodal, bimodal, and polymodal emulsions to maximize oil transportation while keeping lower pressure drops despite high oil content. The unimodal, bimodal, or polymodal dispersion presents a viscosity of less than about 500 cP allowing it to be pumpable and transportable via conventional pipelines. The dispersion, once it arrives at its final destination, is broken or separated by means of one or more suitable diluents such that the remaining oil meets predetermined specifications for further processing, i.e. dehydration and refining into lighter fractions.

### BRIEF DESCRIPTION OF THE DRAWINGS

FIG. 1 is a process flow diagram of a transport process according to an embodiment of the invention;

FIG. 2 is a process flow diagram of a formation stage of a unimodal emulsion according to an embodiment of the invention;

FIG. 3 is a process flow diagram of a formation stage of a bimodal or polymodal emulsion according to an embodiment of the invention;

FIG. 4 is a process flow diagram of an emulsion breaking step according to an embodiment of the invention;

FIG. 5 is a graph representing flow rate effect on droplet size distribution of unimodal emulsions according to an embodiment of the invention;

FIG. 6 is a graph representing effect of surfactant concentration on mean droplet size of emulsions according to an embodiment of the invention;

FIG. 7 is a graph representing mean droplet size as a function of mixing power as the product of pressure drop across the static mixer and flow rate according to an embodiment of the invention;

FIG. 8 is a graph representing apparent viscosity for a 70% unimodal emulsion measured in an experimental one inch pipe loop according to an embodiment of the invention

FIG. 9 is a graph representing mean droplet size as a function of time and surfactant concentration according to an embodiment of the invention;

FIG. 10 is a graph representing mean droplet size evolution according to flow rate in a one stage centrifugal pump according to an embodiment of the invention;

FIG. 11 is a graph representing mean droplet size evolution in a six stages centrifugal pump according to an embodiment of the invention;

FIG. 12 is a graph representing droplet size distribution of two unimodal emulsions mixed to produce bimodal emulsions according to an embodiment of the invention;

FIG. 13 is a graph representing apparent viscosity as a function of shear rate for the emulsions of FIG. 12;

FIG. 14 is a graph representing the effect of addition of an emulsion breaker on water separation at one and 24 hours after dilution using naphta as the diluent; and

FIG. 15 is a graph representing the effect of diluent type on water separation at 24 hours after dilution.

The above summary of the invention is not intended to describe each illustrated embodiment or every implementation of the present invention. The figures and the detailed description that follow more particularly exemplify these embodiments.

### DETAILED DESCRIPTION OF THE DRAWINGS

Transport processes according to embodiments of the invention include an oil and water emulsion that is pumpable and transportable via conventional pipelines, and can be readily separated upon reaching its destination point for further processing. The processes are cost efficient, regardless of the distance from the oil field to the tank farms.

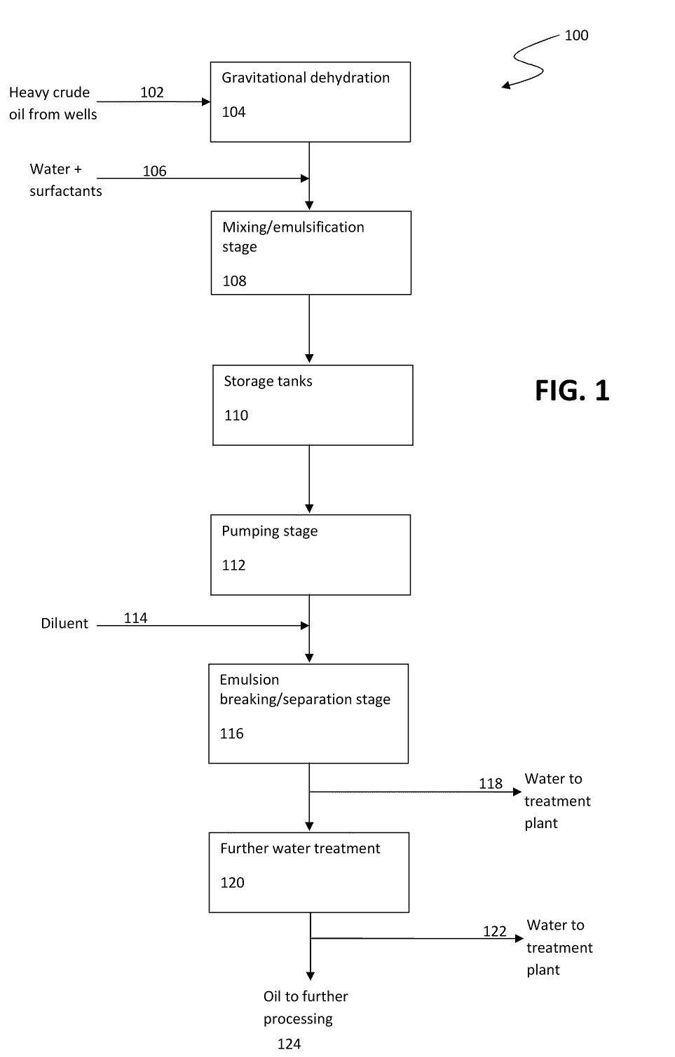

Referring to FIG. 1, pipelining process 100 generally includes an emulsification or mixing stage 108, a pumping stage 112, an emulsion breaking or separation stage 116, and at least one water treatment stage 120.

At 102, heavy crude oil having a density of approximately about 7 to about 14 degrees API and a viscosity of about 10³ to about 10⁶ cP is extracted from the ground. The crude oil can contain salt present in the water as soluble mineral salts. It is desirable to remove the salt from the crude oil to avoid complications in processing downstream, such as in the refining process. Because the salt is present in the water as soluble mineral salts, the removal of water from the crude oil will remove the salt. Therefore, at 104 the heavy crude oil is dehydrated, by using gravitational dehydration or centrifuges, for example, to remove the water.

Once the crude oil is desalted, water and a surfactant system containing one or more surfactants are combined with the crude oil at 106. The water can be fresh water or water from the oil deposit. The source water preferably has a salinity of about 5000 parts per million (ppm) or less; however higher salinity can also be used.

The surfactant system can comprise one or more anionic and/or nonionic surfactants. Anionic surfactants can include cationic surfactants such as quaternary ammonium salts, for example, sodium or bromide alkylamines. Nonionic surfactants can include, for example, primary or secondary ethoxylated alcohols, and/or ethoxylated alkylphenols. The concentration of surfactant can comprise from about 500 to about 10,000 ppm, and more specifically from about 500 to about 3,000 ppm.

At mixing or emulsification stage 108, the crude oil is mixed with about 55 to 20% w/w water content to form an oil in water emulsion. The mixing can be performed between about 35 and about 80 degrees Celsius. The water and surfactant system are combined with the heavy crude oil in emulsification stage 108 by means of static or mechanical blenders or mixers. One such suitable mixer, for example, is the Filmics Mixer, available from the Primix Corporation of Osaka, Japan. The Filmics Mixer and accompanying technology is set forth in U.S. Pat. No. 5,582,484 entitled “Method Of, and Apparatus For, Agitating Treatment Liquid”, which is incorporated herein by reference in its entirety. The emulsion is mixed in the chamber with a slit channel that spins a film of the emulsion components and creates a centrifugal field of about thirteen thousand gs or more.

The resulting dispersion or emulsion contains a crude content between about 45 and about 80 w/w percent. The dispersion can be further diluted with water such that the dispersion is manageable, i.e. efficiently pumpable and transportable, in a conventional pipeline such that the content of crude is between about 45 and about 75 w/w percent. The resulting dispersion or emulsion is then stored in storage tanks at 110, and is then pumped via pipeline at 112 to the tank farm.

Once the oil and water dispersion reaches its destination, i.e. the tank farm, it undergoes a “breaking” or separation stage 116. In one embodiment of the invention, stage 116 is a two-part process. First, a diluent with a density of about 25 and 62 degrees API is added at 114 to the dispersion to facilitate the emulsion separation, and to reduce the density and viscosity of the oil such that the oil is suitable for use and combustible for boilers in refining. Secondly, a basic solution is added at a concentration of about 0.1 to about 0.3% of the dispersion to produce the breaking or rupture of the emulsion, and separation of the crude oil phase from the watery phase. This basic solution can be, for example, a solution of sodium hydroxide or an amine, such as a monoethanolamine or triethanolamine. This basic solution causes the oil and diluents to coalesce and separate from the water.

The oil phase is diluted from the original crude oil phase, and has a water content of about 25% or less. The resulting density of the oil phase is from about 15 degrees API to about 20 degrees API, and preferably about 18 degrees API. The water phase has a crude content of about 5% or less. The water from the water phase is then sent to a water treatment facility at 118 for recovery and reuse. Additional water can be separated from the oil phase at 120 using dehydration processes such as gravitational and/or electrostatic dehydrators and separators such that the oil phase is within density and viscosity specifications for additional processing. This additional separated water can also be sent to a water treatment facility at 122 for recovery and reuse.

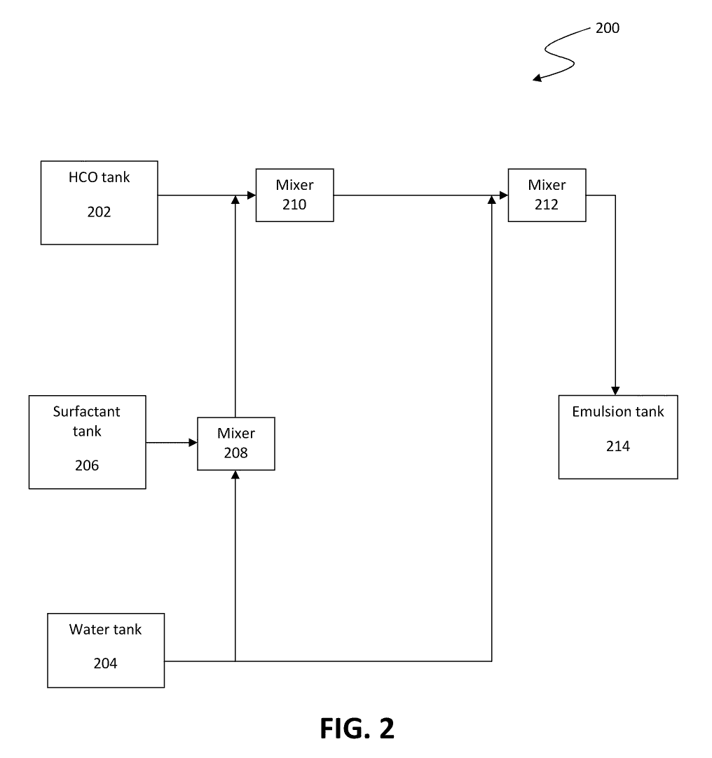

In one embodiment of the invention, referring to FIG. 2, an emulsification stage 200 comprises the formation of a unimodal emulsion. Unimodal emulsification stage 200 generally includes heavy crude oil (HCO) supply or tank 202 and a water supply or tank 204. Water from water supply 204 is optionally mixed with one or more surfactants from surfactant supply or tank 206 at mixer 208. The water optionally containing surfactants is then combined with heavy crude oil from HCO supply 202 at mixer 210 to form a unimodal emulsion. Additional water from water supply 204 can optionally combined with the unimodal emulsion at mixer 212. The unimodal emulsion is then stored in emulsion tank or holding vessel 214. Mixers 208, 210, and 212 can be dynamic mixers, static-dynamic mixers, or static mixers or mechanical mixers as described supra.

Another alternative embodiment of the invention is the manufacturing of bimodal or polymodal emulsions using two manufacturing lines. For example, one line handles about 60 to about 90% of total flow and produces an emulsion having one large mode of about 20 to about 80 μm. The second line can handle about 40 to about 10% of total flow and produces an emulsion having a small mode of about 0.5 to about 10 μm. The two lines combine to produce a single emulsion flow path or current having about a 60 to about 85% crude oil content and a bimodal or polymodal droplet size distribution. The emulsions are formed by means of dynamic mixers, static-dynamic mixers, or static mixers or mechanical mixers as described supra. The bimodal or polymodal emulsion can also be stored in storage tanks and pumped via pipeline to a tank farm.

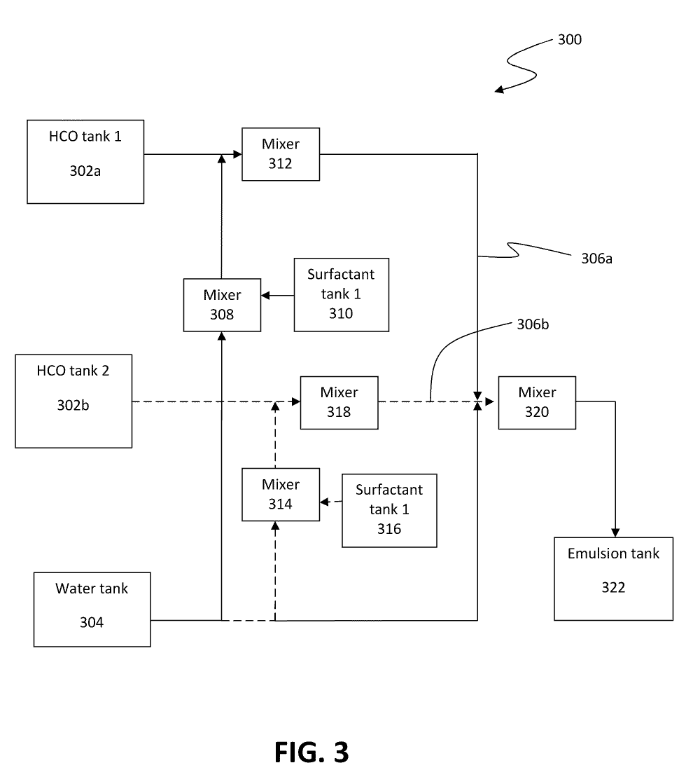

Referring to the exemplary embodiment illustrated in FIG. 3, an emulsification stage 300 comprises the formation of a bimodal or polymodal emulsion. Emulsification stage 300 generally includes two or more HCO supplies or tanks 302 and a water supply or tank 304. In a first path 306a, e.g. a small mode emulsion path, illustrated by solid line, water from water supply 304 is optionally mixed in mixer 308 with one or more surfactants from surfactant supply or tank 310. The water optionally containing surfactants is then combined with heavy crude oil from first HCO tank 302a at mixer 312 to form a small mode emulsion. In a second path 306b, e.g. a large mode emulsion, illustrated by dashed line, water from water supply 304 is optionally mixed in mixer 314 with one or more surfactants from surfactant supply or tank 316. The water optionally containing surfactants is then combined with heavy crude oil from second HCO tank 302b at mixer 318 to form a large mode emulsion. The small mode emulsion path 306a and the large mode emulsion path 306b are then combined with water from water supply 304 at mixer 320 to form a bi- or polymodal emulsion which is then stored in emulsion tank or holding vessel 322. Mixers 308, 312, 314, and 318 can comprise dynamic mixers, static-dynamic mixers, or static mixers or mechanical mixers as described supra.

After the emulsion reaches its destination for further processing, the emulsion is separated or broken. In an embodiment of the invention, to break the emulsion, a diluent with a density of about 25 to about 62 degrees API is added and a surfactant package or emulsion breaker is added to the oil-in-water dispersion. The emulsion breaks, separating part or almost all the water content. The surfactant package or emulsion breaker can comprise any commercial substance that sufficiently produces acceptable water separation from the oil.

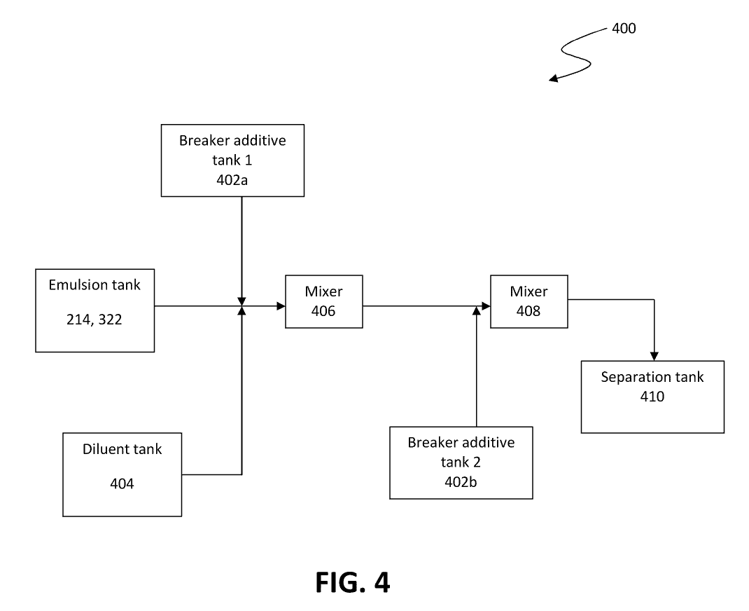

Referring specifically to the exemplary embodiment illustrated in FIG. 4, a separation stage 400 can generally include emulsion tank 214 of FIG. 2 or 322 of FIG. 3, one or more breaker additive supplies or tanks 402, and a diluent tank 404. The uni-, bi-, or polymodal emulsion from emulsion tank 214, 322 is combined at mixer 406 with a first breaker additive from first breaker additive tank 402a and one or more diluents from diluent tank 404. A second optional breaker additive from second breaker additive tank 402b can be combined with the separated emulsion at mixer 408. The separated emulsion can then be stored or sent to separation tank 410 for further processing and separation. Mixers 406 and 408 can comprise dynamic mixers, static-dynamic mixers, or static mixers or mechanical mixers as described supra.

As discussed in the Summary section, dispersions of the present invention include heavy crude oil dispersed within the water phase as droplets having sizes distributed, or a droplet size distribution, between about 0.5 to about 500 μm. This distribution can be referred to as a droplet size distribution and can be represented, for example, in a frequency plot as % volume or mass of droplets of the emulsion as a function of droplet size. Droplet size distributions can be characterized by statistical parameters such as a mean value and a standard deviation. A size distribution of an emulsion can be unimodal meaning that there is a single most frequent value or peak, bimodal (two peak values), or polymodal (more than two peaks). Polymodal emulsions tend to be less viscous than unimodal emulsions, whereas bimodal emulsions that have a large droplet size to small droplet size ratio close to ten, are less viscous than unimodal or polymodal systems.

The viscosity of an emulsion is also a function of oil content. A small increase of oil can have a strong impact on viscosity. Modifying droplet size distribution as explained above can compensate for an increase in oil content by reducing or keeping a constant viscosity.

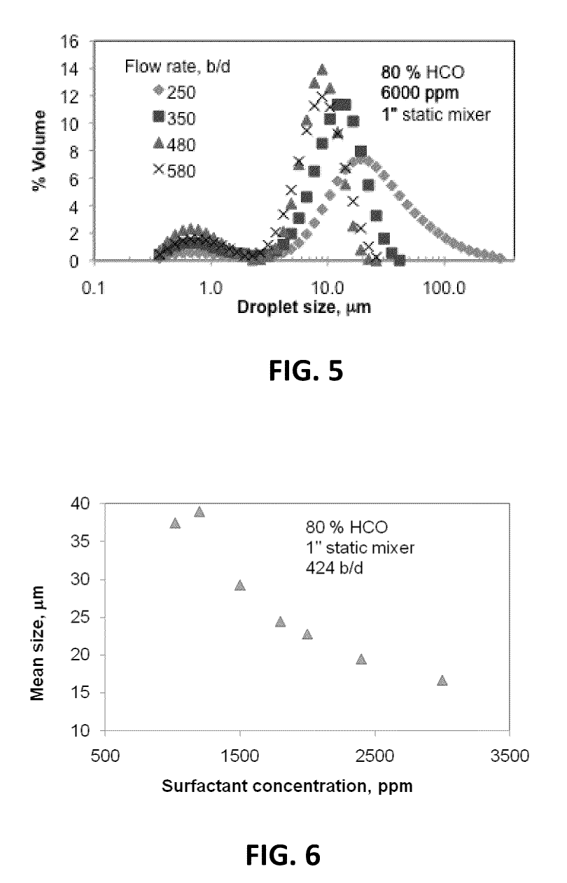

FIGS. 5-7 illustrate formation test results. FIG. 5 illustrates flow rate effect on droplet size distribution. The droplet size of a unimodal emulsion containing 80% heavy crude oil and 6000 ppm surfactant mixed in a one inch static mixer was measured at flow rates of 250, 350, 480, and 580 barrels per day. The lower flow rates typically resulted with a broader distribution with a peak droplet size larger than the higher flow rates. The higher flow rates typically had a tighter distribution.

Referring to FIG. 6, the effect of surfactant concentration on mean droplet size of a unimodal emulsion was plotted. The mean droplet size of a unimodal emulsion containing 80% heavy crude oil with different levels of surfactant mixed in a 1″ static mixer was measured at a flow rate of 424 barrels per day. The mean size of the droplets decreased as surfactant concentrations increased from 500 to 3500 ppm.

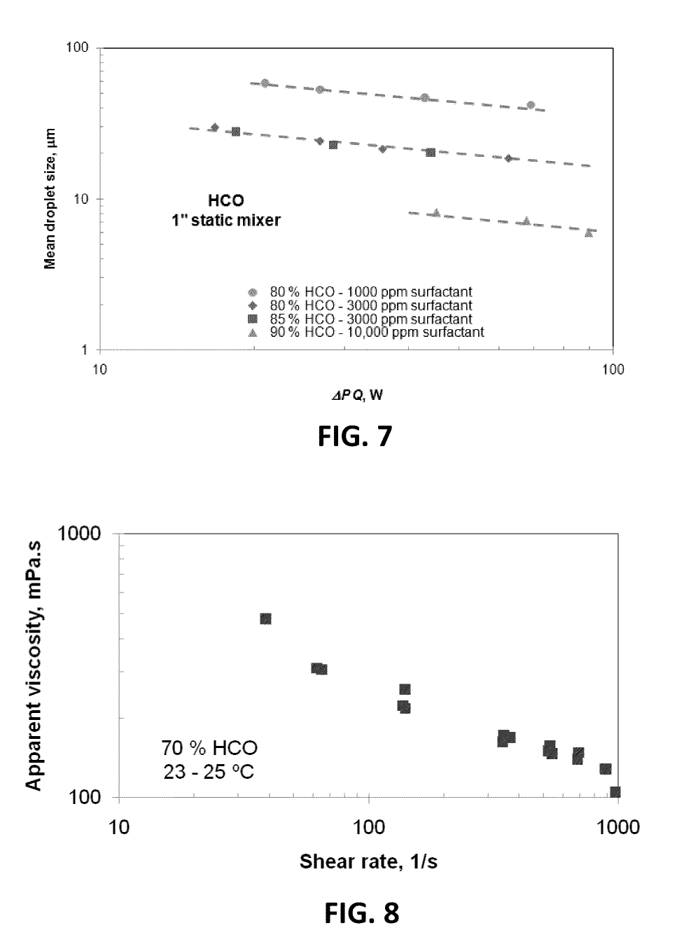

Referring to FIG. 7, the mean droplet size of various emulsions was plotted as a function of mixing power expressed as pressure drop across the static mixer multiplied by flow rate. Emulsions containing 80% HCO with 1000 and 3000 ppm surfactant were measured, as well as an emulsion containing 85% HCO with 3000 ppm surfactant, and an emulsion containing 90% HCO with 10,000 ppm surfactant. For all emulsions, the mean droplet size decreased as power increased. This plot allows process conditions for both small mode and large mode emulsions to be determined.

FIG. 8 is a plot of the viscosity curve for a unimodal emulsion comparing apparent viscosity as a function of shear rate measured at between 23 and 25 degrees Celsius in a one inch experimental loop. The unimodal emulsion contains 70% HCO. The viscosity decreases as the shear rate increases.

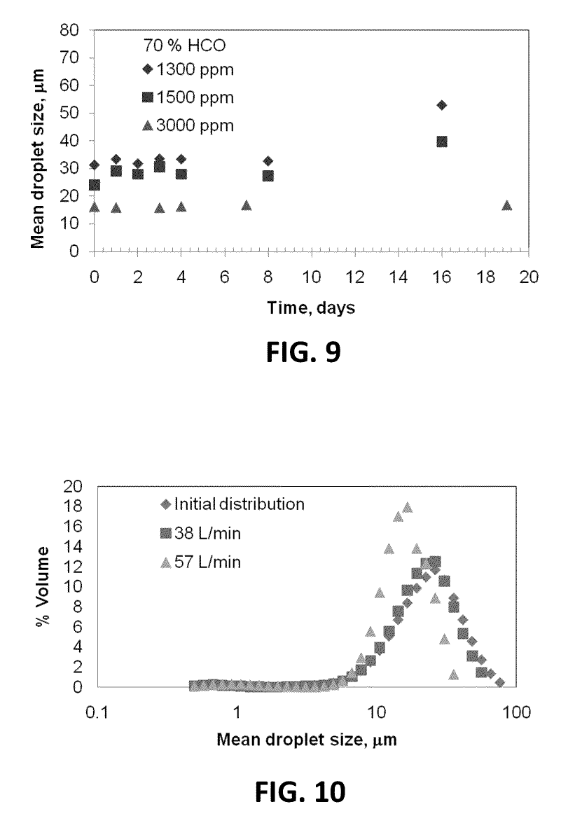

FIG. 9 illustrates static stability of emulsions over time as a function of surfactant concentration. In particular, the mean droplet size of an emulsion containing 70% HCO with various levels of surfactant (1300, 1500, and 3000 ppm) was measured over a course of 20 days. As surfactant concentration increased, the stability of the mean droplet size increased, i.e. the mean droplet size remained unchanged after 20 days.

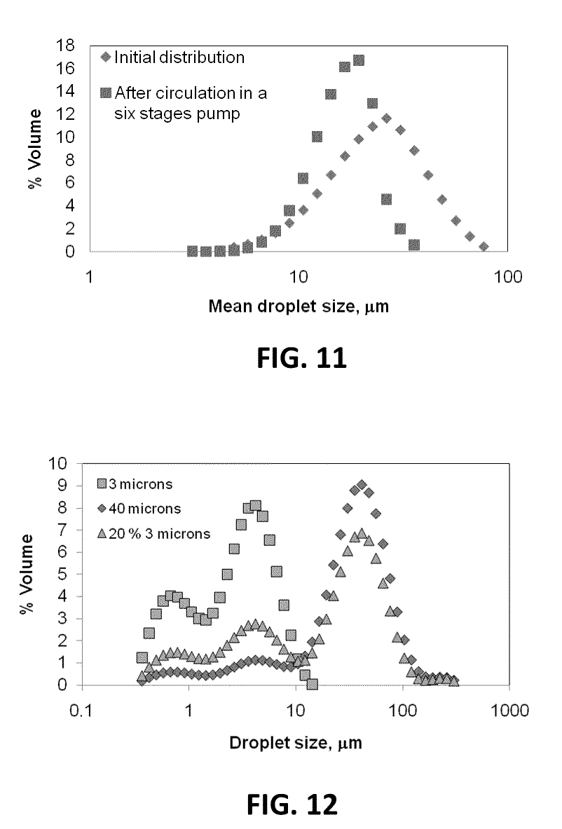

FIGS. 10 and 11 illustrate dynamic stability of emulsions pumped with one stage and six stages centrifugal pumps. FIG. 10 is a plot of the mean droplet size evolution as a function of flow rate in a one stage centrifugal pump. As flow rate increases, the size distribution curve tightens, and the peak droplet size decreases. FIG. 11 is a plot of the mean droplet size evolution in a six stages centrifugal pump. The size distribution curve tightens and the peak droplet size decreases after circulation from the initial distribution.

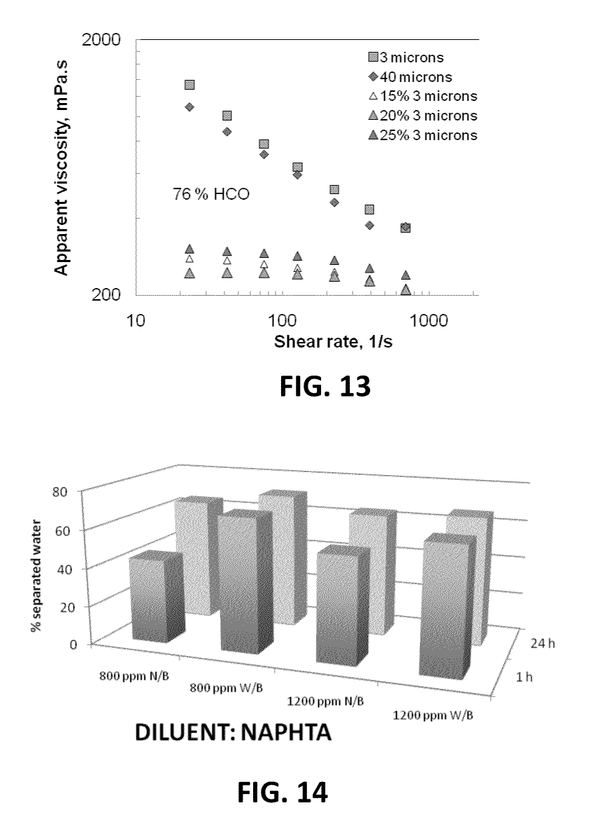

FIG. 12 illustrates the size distribution curves of mixing two substantially unimodal emulsions having peaks at 3 and 40 microns respectively to produce a bimodal emulsion having a volumetric proportion of the small mode emulsion of about 20%. FIG. 13 illustrates that a lower viscosity of a bimodal emulsion containing 76% HCO is obtained when the volumetric proportion of the small mode emulsion is about 20%.

FIG. 14 illustrates the effect of the addition of one or more emulsion breakers on water separation using Naphta as the diluent. In particular, the percent of water separated based on total water in the oil was measured for 65% HCO emulsions containing 800 and 1200 ppm surfactant. The percent water separated is the proportion of all water present in the emulsion that has separated from the diluted HCO. Emulsions broken by addition of a commercially available emulsion breaker (represented as W/B) were compared to those in which no emulsion breaker was added (represented as N/B). The effect was measured at both one and 24 hours after dilution.

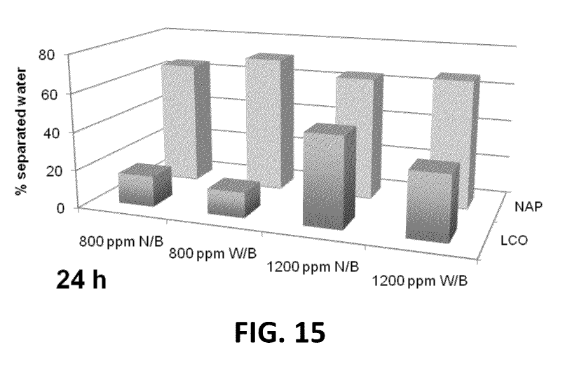

FIG. 15 illustrates the effect of the diluent type with and without emulsion breaker added. The effect was plotted using percent of water separated from the oil for 65% HCO emulsions prepared with 800 and 1200 ppm surfactant. The diluent types included naphta (NAP) having an API of about 60, and light crude oil (LCO) having an API of about 33. The diluents were added in an amount to obtain a diluted crude oil having an API of about 18. The effect was measured after 24 hours of dilution, as the LCO did not produce any water separation after 1 hour of dilution.

The invention therefore addresses and resolves many of the deficiencies and drawbacks previously identified. The invention may be embodied in other specific forms without departing from the essential attributes thereof; therefore, the illustrated embodiments should be considered in all respects as illustrative and not restrictive.

What is claimed is:

1. A pumpable oil and water emulsion comprising:
a water phase;
an oil phase comprising crude oil present in an amount of about 45 to about 80 weight percent; and
a surfactant present in an amount of about 500 to about 3000 parts per million;
wherein the crude oil is dispersed within the water phase as droplets having a droplet size distribution between about 0.5 to about 500 μm.

2. The emulsion of claim 1, wherein a viscosity of the emulsion is about 500 cP or less.

3. The emulsion of claim 1, wherein the emulsion comprises a unimodal emulsion.

4. The emulsion of claim 1, wherein the emulsion comprises a bimodal or polymodal emulsion.

5. The emulsion of claim 4, wherein the emulsion comprises a bimodal emulsion having a large droplet size to small droplet size ratio in a range from about ten to about fifteen.

6. The emulsion of claim 1, wherein the surfactant comprises one or more anionic surfactants, one or more nonionic surfactants, or both.

7. The emulsion of claim 6, wherein the surfactant comprises one or more anionic surfactants selected from the group consisting of quaternary ammonium salts

8. The emulsion of claim 7, wherein the group consisting of quaternary ammonium salts comprises sodium alkylamines, bromide alkylamines, or both.

9. The emulsion of claim 6, wherein the surfactant comprises one or more nonionic surfactants selected from the group consisting of primary, ethoxylated alcohols, secondary ethoxylated alcohols, ethoxylated alkylphenols, and combinations thereof.

10. The emulsion of claim 1, wherein the emulsion is separable by the addition of a diluent having a density of about 25 and 62 degrees API, and a basic solution at a concentration of about 0.1 to about 0.3 weight percent of the emulsion.

11. The emulsion of claim 1, wherein the basic solution comprises a solution of sodium hydroxide, monoethanolamine, or triethanolamine.

12. The emulsion of claim 10, wherein the emulsion is separated such that the oil phase is diluted to a water content of about 25 weight percent or less, and a resulting density from about 15 degrees API to about 20 degrees API.

13. A method of transporting heavy crude oil in emulsion form, the method comprising:
providing a crude oil phase;
providing a water phase; and
combining the crude oil phase and the water phase to form an emulsion having a crude oil content of about 45 to about 80 weight percent, wherein the crude oil is dispersed within the water phase as droplets having a droplet size distribution between about 0.5 to about 500 μm.

14. The method of claim 13, further comprising:
transporting the emulsion from a first location to a second location via pipeline; and
breaking the emulsion at the second location such that a resulting oil phase is diluted to a water content of about 25 weight percent or less, and a resulting density from about 15 degrees API to about 20 degrees API.

15. The method of claim 14, wherein breaking the emulsion comprises:
adding a diluent having a density of about 25 and 62 degrees API to the emulsion;
adding at least one emulsion breaker to the emulsion, wherein the emulsion breaker comprises a basic solution at a concentration of about 0.1 to about 0.3 weight percent of the emulsion.

16. The method of claim 15, wherein the basic solution comprises a solution of sodium hydroxide, monoethanolamine, or triethanolamine.

17. The method of claim 15, wherein the diluent comprises naphta having an API of about 60 degrees, light crude oil (LCO) having an API of about 33 degrees, or both.

18. The method of claim 13, wherein the emulsion comprises a unimodal, bimodal, or polymodal emulsion.

19. The method of claim 18, wherein the emulsion comprises a bimodal emulsion formed by:
forming a first, small mode emulsion by combining the water phase and a first crude oil phase;
forming a second, large mode emulsion by combining the water phase and a second crude oil phase;
combining the small mode emulsion, the large mode emulsion, and the water phase thereby forming the bimodal emulsion.

20. The method of claim 19, wherein the bimodal emulsion has a large droplet size to small droplet size ratio in a range from about ten to about fifteen.
